(19) United States
(12) Patent Application Publication
(10) Pub. No.: US 2007/0270064 A1
(43) Pub. Date: Nov. 22, 2007

(54) Carpet primary backing having enhanced tufting and tuft securing characteristics

(76) Inventor: Lester M. Aseere, Parker, CO (US)

Correspondence Address: JOHNS MANVILLE, 10100 WEST UTE AVENUE, LITTLETON, CO, 80127, US

(21) Appl. No.: 11/438,732

(22) Filed: May 22, 2006

(51) Int. Cl. B32B 27/04; B32B 27/12; B32B 27/14; B32B 33/00; B05D 1/04

(52) U.S. Cl. 442/150; 428/87; 428/95; 428/96; 156/72; 427/458; 427/475; 442/44; 442/149

(57) ABSTRACT

A primary carpet backing is provided for use in the formation of a tufted carpet which eliminates or reduces the need for a latex adhesive layer or the use of a secondary backing. The external surfaces of a woven or non-woven fibrous mat are coated with thermoplastic polymer particles having a lower melting temperature than the fibers of the mat. The mat possesses sufficient openings between fibers to be capable of undergoing tufting. Following tufting the tufted mat is heat treated so as to melt the thermoplastic polymer particles and to create a bond between the tufted carpet yarn fibers and the primary backing mat.

### BACKGROUND OF THE INVENTION

1. Field of the Invention

The present invention relates to a primary carpet backing mat and more particularly, to a mat wherein the mat fibers have a coating that changes state during a post process carried out after a tufting operation, whereby the coating acts as an adhesive that bonds and retains tufted carpet fibers in the primary carpet backing, thereby eliminating or reducing the need for the application of a latex adhesive layer or use of a secondary backing.

2. Description of the Prior Art

Carpets are conventionally manufactured by tufting fibrous yarns into a primary backing mat using a needling operation. The fibrous yarns that undergo tufting may be in the form of a continuous yarn or as previously cut yarns. These yarn(s) may be fed to a needle-punching machine for the tufting process. The characteristics of the primary backing mat fibers determine how the tufted fibers are held in place by the primary backing mat. A latex adhesive layer is applied to the underside of the carpet in order to hold the tufted fibers in place. In addition, a secondary backing mat is used below the latex adhesive layer, retaining the latex adhesive. After the tufting process, but before the latex adhesive has been applied, the tufts are susceptible to dislodgment from the primary backing. Rework is often necessary between these steps to insert any of the dislodged or absent tufts before the latex adhesive is applied. Traditionally, the latex application process is burdensome since the latex adhesive must first be compounded. Then latex water must be driven off and the latex adhesive must be cured. Finally, after the latex adhesive is cured it must be cooled. In addition, carpet manufacturers have traditionally required a secondary backing to be applied after the application of the latex adhesive. The secondary backing is usually required to protect the latex from damage and thereby hold the tufts more securely in their proper position within the primary backing and provide a non-abrasive surface that provides appropriate friction coefficient against the sub flooring over which the carpet is installed. These additional steps of applying a latex adhesive followed by a secondary backing mat are not only burdensome, but also drive up the overall carpet manufacturing costs. Increased transportation costs also result, as the carpet is heavier due to the latex adhesive and secondary backing. This heavier carpet is also less flexible.

It would be extremely desirable if a carpet could be constructed that did not require the use of a latex adhesive or to reduce its usage or the need for a secondary backing mat. It would also be desirable if the latex and secondary backing free carpet construction facilitated enhanced bonding of the tufted carpet yarns so that they would be held securely in place. Furthermore, it would be advantageous if the constructed carpet had readily bendable and flexible properties that were lacking in carpets heretofore devised and utilized, so that the constructed carpet could be more easily installed around tight corners, such as stairs.

U.S. Pat. No. 4,439,476 to Guild discloses a tufted pile fabric. A separate fiber layer of “Grilon” is disposed underneath the primary backing, which comprises a polyamide fiber layer having a melting point of 115° C. The carpet pile is tufted through the primary backing, together with the “Grilon” layer and the “Grilon” layer is melted to affect a bond between the tufted pile and the primary backing material. Most polyamides melt in the range of 225° C. to 250° C. and this melting point of 115° C. for “Grilon” appears low for a polyamide fiber layer. The melting of the “Grilon” fiber layer tends to drip down rather than form a bond to the needled tuft pile unless the fusing is carried out upside down, in which case, the melted layer reduces the flexibility of the carpet formed.

U.S. Pat. No. 4,579,763 to Mitman discloses a process for forming densified tufted carpet tiles by shrinking the primary backing. The backing is made from polyolefin and is tufted with carpet yarn pile. The structure is heated to a temperature not less than 300° F. to heat shrink the primary backing so that the carpet yarn pile is captured. Since the backing contracts by as much as 130 percent, the overall dimension of the carpet is not preserved. Furthermore, shrinkage along various directions is dependent on thermal cycles during processing and thus produces non-uniform carpets. The capturing of tufted carpet pile yarn is not reliable, and a secondary backing is needed to assure that the tufted carpet yarn is held in place.

U.S. Pat. No. 4,705,706 to Avery discloses a tufted carpeting having stitches thermally bonded to a backing. The back-loops of the stitches of tufted carpet pile yarn are fastened to the backing by thermal bonding thereby obviating the need for the application of an adhesive coating to the underside of the backing. The tufted pile yarn incorporates a low melting polymer such as polyethylene and the underside of the tufted carpet is heated to melt the low melting polymer in the yarn pile. The melting of the low melting polymer creates a bond between the carpet yarn pile and the primary backing. This requires the incorporation of a large quantity of the low melting polymer in the tufted carpet fiber yarn, and only those low melting polymer fibers present on the surface of the tufted carpet yarn contribute to the bonding process. Disadvantageously, the presence of unmelted polyethylene fiber in the carpet yarn reduces its carpet feel and spring back characteristics.

U.S. Pat. Nos. 5,532,035 and 5,630,896 to Corbin et al. (herein the '035 and '896 patents) disclose a recyclable thermoplastic tufted fabric and a method of making recyclable tufted carpets, respectively. The recyclable thermoplastic tufted fabric is made of a partially meltable primary backing and tufts of yarn tufted into the primary backing. The tufts are bonded to the backing by partially melting the primary backing to bond the tufts. A secondary backing having a similar composition to the primary backing is applied so that the carpet can be recycled. The '035 and '896 patents teach away from the use of dissimilar polymeric materials for bonding a carpet pile yarn to the primary backing. Also, it is the primary backing fibers that melt to create a bond, but such melting creates holes surrounding the tufted fibers with only localized bonding and this bond cannot effectively secure the tufted yarn. The disclosure addresses use of polyester carpet fiber yarn tufted into a primary backing that includes polyester yarn with a low melting polyester composition of heterofil or homofil polyester binder fiber that can be melted during a heating cycle to create a bond between tufted carpet yarn and the primary backing. No low melting backing compositions are provided in the disclosure for nylon-based carpet or a polypropylene based carpet.

U.S. Pat. No. 5,536,551 to Woosley discloses a method for binding tufts using a mixture of high melting and low melting fibers in the backing and the tufted carpet pile yarn. The high-melt filaments are preferably polyester or nylon and the low-melt filaments are preferably polypropylene or polyethylene. Heating the carpet melts the low melting fiber in the primary backing as well as the tufted caret pile, creating a bond between the primary backing and the tufted carpet yarn. Unfortunately, heating the carpet completely bonds the tufted carpet yarn at the face of the carpet thereby making the carpet fibers stiff, and reducing or eliminating the soft pliable characteristics of the carpet produced. The drawing shows bonding of the carpet fibers approaching about one-third of its pile length.

U.S. Pat. No. 5,538,776 to Corbin et al. (herein the '776 patent) discloses a carpet containing a hot melt polyester layer. Specifically, the '776 patent discloses a thermoplastic tufted carpet made of a polyester primary backing. Polyester fibers are tufted into the primary backing and secured through application of a poly(butylene terephthalate) polyester hot melt adhesive followed by a polyester secondary backing. As a result, the tufted fibers are disposed between the primary and secondary backing. The carpet is comprised entirely of polyester. Such a carpet can be recycled through processes known to recycle polyester including glycolysis or methanolysis. The recyclable carpet is comprised of polyester fibers tufted into a polyester primary backing, a polyester secondary backing and a poly(butylene terephthalate) hot melt adhesive, effectively adhering the polyester tufted primary backing and the polyester secondary backing. This approach does not eliminate the secondary backing, and results in a stiff, difficult to bend carpet. In addition, the '776 patent teaches away from the use of dissimilar polymeric materials for bonding a carpet pile yarn to the primary backing.

U.S. Pat. No. 5,604,009 to Long et al. discloses a non-adhesive bonded tufted carpet and method for making the same. The non-wet processed tufted carpet includes a plurality of face yarns. These face yarns are tufted into and through a primary backing fabric. A secondary backing fabric is applied to more securely hold the yarns in place. However, no adhesive binder is used. The secondary backing fabric locks the face yarns in place upon the application of heat to a non-wet surface of the secondary backing fabric non-adjacent to the primary backing fabric. Preferably, the carpet uses mixtures of high and low melting polymers, including nylon and polypropylene, for the tufted yarns, the primary backing, and the secondary backing. As a result, the tufted yarn is trapped and secured within the primary and the secondary backing when the tufted carpet is processed through a heating cycle that melts the low melting polymer. This process does not eliminate the need for a secondary backing. Furthermore, the melting of the tufted yarns, the primary backing, and the secondary backing fibers results in a substantially rigid carpet with limited flexibility. Moreover, the melting of the tufted carpet yarn face fibers results in a poor carpet feel, since the fibers become stiff.

U.S. Pat. No. 5,660,911 to Tesch discloses a tufted carpet and a process for producing the same. The tufted carpet yarn is passed through sections of a polyethylene sheet placed behind the primary backing. Thereafter tufting, heat is applied in the form of warm rolling. This heat melts the polyethylene sheet, bonding the back ends of the tufted carpet yarn to the primary backing. A secondary backing sheet may also be employed in order to retain the tufted carpet fiber. Where the secondary backing sheet is used the sections of the polyethylene sheet are bonded to the secondary and the primary backing, thereby entrapping the back ends of the tufted yarn. The bond is only created between the very back end of the tufted yarn and the primary backing mat since the polyethylene sheet is placed on the underside of the primary mat. As a result, the adhesive is not present between the tufted yarn and the primary mat yarn, creating a very weak bond between the tufted yarn and the primary backing. A secondary backing is relied on to secure the tufted yarn, thereby reducing the flexibility of the carpet.

U.S. Pat. No. 5,925,434 to Phillips et al. discloses tuftable backing and carpet construction. Serrated tuftable backing material is coated with a thin layer of polyethylene so that the tufted fibers can be bonded to the serrated backing tape by thermal processing, which melts the thin polyethylene layer. The thermoplastic serrated tape yarn comprises at least 85 weight percent polypropylene, wherein at least 50 percent of the yarns in the woven fabric are serrated with a thermoplastic polymeric layer adhered to the fabric. The thermoplastic serrated tape yarn of the backing material with a melted adhesive layer limits the flexibility of the carpet. The adhesive is only present between the back ends of the yarn and the serrated tape and it is not between the backing and the tufted fiber. As a result, the bond strength of the tufted fiber is limited.

U.S. Pat. Nos. 6,060,145 and 6,344,254 to Smith et al. (herein the '145 and '254 patents) discloses a modified secondary backing fabric, a method for the manufacture thereof and a carpet containing the same. A primary backing is bonded using latex to bond the tufted carpet yarn and to attach the modified secondary backing. The use of scrim in the secondary backing provides a softer back and improved flexibility. The '145 and '254 patent disclosures eliminate neither the latex bonding procedure nor the secondary backing material.

U.S. Published Patent Application No. US 2003/0211280 to Brumbelow et al. discloses a carpet, carpet backings and methods of making them. The contemplated carpet tile includes a primary backing, a plurality of fibers attached to the primary backing and extending into the back surface of the primary backing, an adhesive backing placed at the back surface of the primary backing, and an optional secondary backing adjacent to the adhesive backing. The adhesive backing is made from a homogeneously branched linear ethylene polymer. The method includes extrusion coating of the homogeneously branched linear ethylene polymer onto the back surface of a primary backing to provide an adhesive backing. The method of making the carpet comprises attaching tufted yarn to a primary backing material with an adhesive backing material. The adhesive backing material is composed of a first ethylene polymer layer with a higher melt index that is in intimate contact with the back surface of the primary backing material. This layer substantially penetrates and consolidates the yarn. An optional second ethylene polymer layer with a lower melt index may be applied to the first ethylene polymer layer directly onto the back side of the primary backing material. This second ethylene polymer layer is applied, together with an optional secondary backing, and is heated to fabricate a carpet tile. The adhesive polymer is a maleic anhydride grafted ethylene copolymer. The carpet is heated to melt the first, and optionally the second adhesive layer. This is a construction method for manufacture of carpet tile, not a carpet. The adhesive layer of meltable polymeric material is present below the underside of the primary backing and, as a result, any bonding between the tufted yarn and the primary backing only occurs at the backside of the tufted yarn. No adhesive is present between the primary backing yarn and the tufted fiber. As a result, a secondary backing mat is used to firmly anchor the tufted yarns in the carpet tile.

Notwithstanding the advances in the field of primary backing mats and related carpet manufacturing methods, there remains a need in the art for a readily bendable, flexible, light weight carpet that retains tufted carpet yarn effectively with superior tufted yarn pull out resistance.

### SUMMARY OF THE DISCLOSURE

The present invention provides a primary backing mat, woven or non-woven, having individual mat fibers that are substantially coated with particles of a thermoplastic polymer material that has a melting point lower than that of the mat fibers. This coating process may be accomplished by spraying an aqueous dispersion of thermoplastic polymer particles onto the woven or non-woven primary backing mat and drying the mat to form the coating. Alternatively, the coating process may be accomplished by electrostatic coating. The thermoplastic polymer particles cover substantially the exterior surface of the mat fibers and are bonded in place by electrostatic charge or Van der Waal forces. This bond can be enhanced by subjecting the coated primary backing mat to a temperature sufficient to soften the thermoplastic polymer particles and make them tacky. The coated primary mat is supplied to carpet tufting machines wherein carpet yarn having a melting temperature greater than that of the thermoplastic polymer particles is needled into the openings or apertures between the primary backing mat fibers. The tufted primary backing mat is then subject to a post needling process wherein it is heated to a temperature sufficient to change the state of or melt the thermoplastic polymer particles. As a result of the melting of the polymer particles, a permanent bond is created between the tufted carpet yarn and the fibers of the primary backing mat. Since the fibers of the primary backing mat carry the thermoplastic polymer particles on the surface, these thermoplastic polymer particles are present between the tufted carpet yarn and the mat fiber. This intimate presence provides a complete bond that encircles the primary backing mat fiber, providing high pull out strength for tufted carpet fibers. The single step heating operation provides a carpet that does not require any or only a reduced quantity of a latex adhesive or secondary backing on the underside of the carpet. As a result, the carpet is lightweight and is highly bendable and is capable of being installed with ease around tight corners and stairways. The melted and solidified thermoplastic polymer is only present between the tufted carpet yarns and the mat fiber is free to bend in between the tufted carpet yarns.

Key requirements are that the mat fibers and the carpet tufted yarn have a higher melting temperature than that of the thermoplastic polymer particles that are applied as a coating to the primary backing mat fibers. Several combinations satisfy this requirement. Polyethylene thermoplastic polymer particles can be applied on primary backing mat fibers selected from one or more of nylon 6, nylon 6,6, nylon 6,10, nylon 6,11, polyester, polypropylene, and jute. The molecular weights of the thermoplastic polymer particles are selected so as to well facilitate melt flow upon the application of heat. The carpet yarn fibers may be selected from a list comprising nylon 6, nylon 6,6, polyester, polypropylene, wool, or combinations of these. However, when polypropylene thermoplastic polymer particles are used to coat the primary backing mat fibers, all fiber combinations recited above may be used, except polypropylene mat and polypropylene carpet tufting yarns cannot be used.

A unique method and means are thereby provided for constructing a carpet without the use of a latex adhesive or a second backing mat or through the use of a latex adhesive in a reduced quantity. The carpet construction facilitates enhanced bonding of the tufted carpet yarns so that they are held securely in place. Carpet constructed in accordance with the present invention has readily bendable and flexible properties that are lacking in carpets heretofore devised and utilized. As a result, carpet constructed using the method and means of the invention can be more easily installed around tight corners, such as stairs.

### BRIEF DESCRIPTION OF THE DRAWINGS

The invention will be more fully understood and further advantages will become apparent when reference is had to the following detailed description of preferred embodiments of the invention and the accompanying drawings, in which:

FIG. 1 is a schematic diagram depicting a conventional carpet construction;

FIG. 2 is a schematic diagram depicting a carpet construction in accordance with the invention; and

FIG. 3 is a schematic diagram depicting a carpet construction showing a carpet primary backing having enhanced tufting and tuft securing characteristics immediately after post heat treatment.

### DETAILED DESCRIPTION OF PREFERRED EMBODIMENTS

Carpets are routinely manufactured by tufting carpet yarn through the interstices of a woven or non-woven primary backing mat. The needling operation passes continuous or discontinuous staple yarn through the interstices of the backing mat, creating the carpet facing. The ability of the tufted yarns to be held within the primary backing mat is strongly related to the spring back characteristics of the primary backing mat. The spring back properties are a strong function of the primary backing mat's yarn type and weave pattern. The carpet is moved from the tufting station to a second station that applies an adhesive latex layer on the underside of the tufted primary mat. Frequently, after the tufting process, but before the latex adhesive has been applied, the tufts are susceptible to dislodgment from the primary backing. In such cases, rework is required between these steps to reinsert any tufts that were dislodged before the latex adhesive is applied. Traditionally, the latex application is burdensome, since it requires compounding, removing water, curing, and finally cooling. A secondary backing mat is generally applied under the primary mat to contain the latex adhesive and to securely trap the tufted carpet yarn. The use of the latex adhesive and the secondary backing mat increases the cost to manufacture the carpet. Furthermore, the use of the latex adhesive and the secondary backing mat results in a heavier carpet that is reflected in the cost of transporting the carpet. Lastly, the use of the latex and secondary backing yields a less bendable carpet that cannot be easily installed on stairs or around tight corners.

The present invention addresses the problems and costs associated with requiring the application of a substantial quantity of separate latex adhesive and the use of a secondary backing mat during carpet manufacturing. The present invention provides a primary backing for a carpet, which changes state via a post process and becomes an adhesive layer that permanently bonds the carpet fibers in place. Generally stated, the invention relates to a primary backing for a carpet that provides good gripping of the carpet fibers without the need of a substantial quantity of an adhesive layer, such as latex, or use of a secondary backing mat. The primary backing mat is constructed with high melting mat fibers that are bonded with lower melting polymeric particulate matter incorporated on its surface. The primary backing mat is tufted with carpet yarn, whereby the lower melting polymeric particles are placed in between the tufted carpet yarn and the primary backing mat fiber. During the post thermal heating process the underside of the carpet is heated to a temperature sufficient to change the state of the low melting polymeric particles. The low melting polymeric particles melt and completely surround the primary backing mat fiber, thereby capturing the tufted carpet yarn. When the carpet is cooled, the low melting polymer solidifies and thereby acts as an adhesive, providing complete contact of the tufted yarn loop with the primary backing mat fiber. This bond strength is sufficient to provide pull out resistance of the tufted carpet yarn, avoiding or reducing the need for a latex adhesive or a second backing mat. Since the adhesive is only present between the primary backing mat yarn and the tufted carpet yarn, the fabricated carpet is thin, lightweight, and is highly flexible.

The low melting polymeric particulate coating may be selected from a number of polymeric types. Low density polyethylene melts at a temperature of approximately 115° C. (e.g., approximately 115 to 120° C.) while high density polyethylene melts at a temperature of approximately 135° C. (e.g., approximately 135 to 140° C.). Polypropylene melts at temperatures of approximately 160° C. (e.g., approximately 160 to 175° C.). Nylon 6 has a melting temperature of approximately 210 to 220° C., while nylon 6,6 has a melting temperature of approximately 225 to 265° C. Also, jute fibers do not readily melt. Therefore, there are a number of combinations of high melting backing fibers that may be coated with the lower melting polymeric particulate matter. For example, a polypropylene backing fiber may be coated with particles of low or high-density polyethylene. Nylon 6 or 6,6 backing fibers may be coated with low or high-density polyethylene particles or polypropylene particles. A jute backing fiber may be coated with low- or high-density polyethylene particles or polypropylene particles or nylon 6 or 6,6 particles. The post heat treatment temperature must be chosen so that the coated polymeric particles melt to create a bonding adhesive. Also, the tuft fiber must be chosen so that it does not melt at the post heat treatment temperature. The tufted fiber yarn may be wool, cotton, nylon 6 or nylon 6,6 or polypropylene, and combinations of these. The lower melting polymeric particulate coating may be readily chosen based on the selection of the post heat treatment temperature. One of the unique characteristics of low or high-density polyethylene particles is that they readily bond to nylon 6 or nylon 6,6 fibers when melted. This unique characteristic defines a preferred combination of nylon backing fibers coated with low- or high-density polyethylene particulate matter tufted with nylon pile yarn. When polyethylene is used, the post heat temperature can be at approximately 115° C. or 135° C., depending on whether the polyethylene is low- or high-density.

The lower melting polymeric matter may be coated on the high melting primary backing fibers using processing steps selected from a number of options. The high melting fibers may be woven, knitted, or non-woven to define a backing mat and the lower melting polymeric particulate matter may be dispersed as a suspension in a liquid carrier and sprayed to coat the backing. The liquid carrier may be evaporated by heating. Alternatively, a dry powder coating of the low melting polymeric powder may be applied using an electrically charged sprayer. In this embodiment the woven or non-woven mat of fibers are charged with an electrostatic charge, and the thermoplastic particles are charged with an opposite charge and are distributed in an air stream that passes adjacent the charged mat so as to deposit the thermoplastic particles on the mat. In a second embodiment, the coated primary backing fiber mat may be heated to tack the lower melting polymeric particles to the high melting fiber. The resultant primary backing mat may be supplied as a roll for tufting of pile fibers to form a carpet.

The following advantages are made possible by the present invention: (i) elimination or reduction of the wet latex adhesive application process; (ii) immediate in-line adhesion of tufted yarn fibers to the backing after post heat treatment, resulting in less defects and need to rework; (iii) reduction of energy costs customarily needed to drive off a substantial quantity of latex water and cure; and (iv) overall improvement of process speeds that can be increased to the speed of the tufting machines. The end result provides the desired advantages of a lightweight, flexible carpet, while avoiding the undesired defect/re-work characteristics of the current carpet manufacturing process.

The key features associated with the enhanced carpet primary backing include, in combination: (i) a high melting carpet primary backing mat; (ii) the high melting backing mat fibers is covered with a coating of lower melting thermoplastic polymer particles; (iii) the carpet tufting yarn is needled into openings in between fibers of the primary backing mat; (iv) the resulting construction is subjected to a post process that melts the lower melting thermoplastic polymer particle coating of the primary backing mat to form an adhesive that bonds the tufted yarn with the backing; (v) the resulting construction is cooled; (vi) the adhesive forms a permanent bond between the carpet yarn and the primary backing; (vii) the need for a separate latex adhesive is reduced or is obviated, and (viii) the need for a carpet secondary backing is reduced or is completely obviated.

The primary backing mat may be made from a single polymeric composition or mixtures of polymeric compositions including weave patterns that use dissimilar yarns in the weaving process or use twisted or braided yarns of different polymeric compositions.

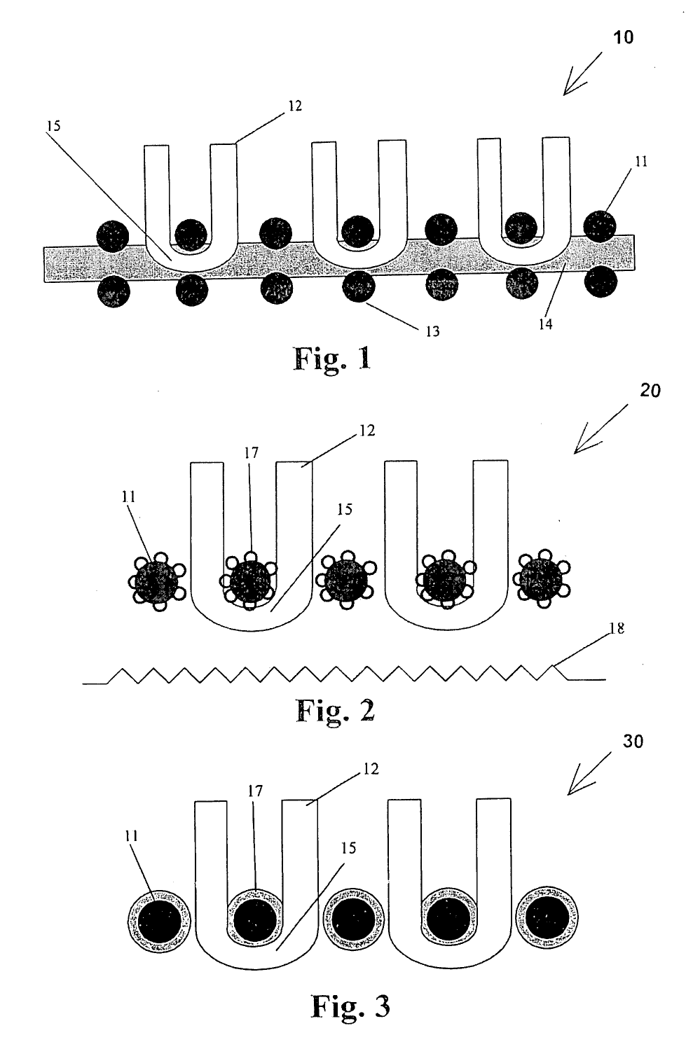

Referring to FIG. 1 of the drawings, there is shown generally at 10 a schematic diagram depicting a conventional carpet construction. Carpet 10 consists of: (i) a primary backing; (ii) carpet fibers tufted into the primary backing; (iii) an additional latex adhesive wet-applied to the back side of the primary backing; and (iv) a secondary backing. The carpet yarns 12 are tufted into the primary backing 11, wherein the cross-sections of the individual fibers of the primary backing are shown as darkened circles. The tufted yarn carpet forms a loop at 15. The backing is coated with an adhesive layer 14 and is held by a secondary backing 13.

Referring to FIG. 2 there is shown generally at 20 a schematic diagram depicting the carpet primary backing having enhanced tufting and tuft securing characteristics immediately after tufting. At this stage of the carpet manufacturing process, the construction comprises: (1) a primary backing created with high melting fibers that are coated with lower melting polymeric particulate matter; and (ii) carpet fibers tufted into the primary backing with the lower melting polymeric particulate matter resident in between the tufted yarn and the high melting fibers of the backing. A carpet primary backing having enhanced tufting and tuft securing characteristics, in the as-tufted condition, is shown at 20. Carpet yarns 12 are tufted into the primary backing 11, wherein the cross-sections of the individual fibers of the primary backing 11 are shown as darkened circles. Primary backing 11 is coated with lower melting polymeric particles, shown at 17. Tufted carpet yarns 12 form a loop 15, which may encircle the primary backing 11, coated with low melting polymeric particles 17 as shown. Alternatively, the tufted carpet yarns 12 may be a free dangling loop (not shown). After the carpet yarns 12 are tufted into the primary baking 11, coated with lower melting polymeric particles 17, the resultant carpet is taken to a post heat treatment station. The post heat treatment station may be in line or off line, and is set at the required temperature to melt the lower melting polymeric particles 17. As the low melting polymeric particles 17 melt, an adhesive is formed, which permanently bonds the tufted carpet yarns 12 to the primary backing 11. The heating may be conveniently applied at 18, as shown.

Referring to FIG. 3 there is shown generally at 30 a schematic diagram depicting the carpet primary backing having enhanced tufting and tuft securing characteristics immediately after post heat treatment. At this process stage, the construction consists of: (i) a primary backing with high melting fibers coated with melted lower melting polymeric particulate matter; and (ii) carpet fibers tufted and permanently bonded into the primary backing. The carpet primary backing having enhanced tufting and tuft securing characteristics is shown in the as tufted and post heat treated condition 30. Carpet yarns 12 are tufted into the primary backing 11, wherein the cross-sections of the individual fibers of the primary backing are represented by darkened circles. Primary backing 11 is coated with melted lower melting polymeric particles, shown at 17. Tufted carpet yarns 12 form a loop at 15, which may encircle the primary backing 11 coated with lower melting polymeric particles 17, as shown. Alternatively, the tufted carpet yarns 12 may be a free dangling loop (not shown). The melted lower melting polymeric particles 17 form a permanent bond between the tufted carpet yarns 12 and the primary backing 11. The entire loop 15 of the tufted carpet yarns 12 encircles the primary backing 11 with melted and solidified lower melting polymeric particles 17 therein between.

The carpet primary backing having enhanced tufting and tuft securing characteristics is produced by a method comprising the steps of (i) selecting fibers for a primary backing mat that are higher melting polymeric materials; (ii) manufacturing the primary backing mat either by weaving or using non-woven mat preparation processes; and (iii) coating each mat fiber with lower melting polymeric particles. The lower melting polymeric particles may be bonded to the primary backing mat by electrostatic forces or Van der Waal type forces. The bond between the lower melting polymeric particles and the primary backing mat fibers may be improved by subjecting the coated primary backing mat to a temperature sufficient to make the particles sticky and tacks the particles without melting. The primary backing is subjected to carpet yarn tufting followed by a post heat treatment. The post heat treatment changes the state of the lower melting polymeric particles, causing the particles to adhere and permanently bond the tufted carpet yarns to the primary backing mat.

Having thus described the invention it is to be understood that such detail need not be strictly adhered to, but that additional changes and modifications may suggest themselves to one skilled in the art, all falling within the scope of the invention as defined by the following claims.

What is claimed is:

1. A primary backing mat, comprising:
(a) a mat formed by woven or non-woven fibers, and
(b) said mat fibers having external surfaces, wherein said external surfaces are substantially coated with thermoplastic polymer particles having a melting temperature lower than that of said mat fibers, said thermoplastic polymer particles being anchored to the surface of said mat fibers and thereby effectively coating said mat, and said mat being coated with said thermoplastic polymer particles having openings between said mat fibers, wherein said mat is capable of being needled by a tufting machine with carpet yarn fibers to form a carpet having tufted carpet yarn fibers, said tufted carpet yarn fibers having a melting temperature greater than that of said thermoplastic polymer particles coated on said mat fibers,
whereby subjecting said carpet to a post heat treatment process melts said thermoplastic polymer particles to create a bond between said tufted carpet yarn fibers and said mat fibers, thereby eliminating minimizing the need for a latex adhesive or a secondary backing mat on the underside of said carpet.

2. A primary backing mat according to claim 1, wherein said mat fibers are selected from the group consisting of nylon 6, nylon 6,6, polyester, polypropylene, and mixtures of the foregoing.

3. A primary backing mat according to claim 1, wherein said thermoplastic polymer particles are composed of polyethylene or polypropylene.

3. A primary backing mat according to claim 1, wherein said tufted carpet yarn fibers are selected from the group consisting of nylon 6, nylon 6,6, wool, polyester, polypropylene fibers, and mixtures of the foregoing.

4. A primary backing mat according to claim 1, wherein said mat fibers are nylon 6 fibers coated with polyethylene particles and are tufted with nylon 6 carpet yarn fibers.

5. A primary backing mat according to claim 1, wherein said thermoplastic polymer particles are anchored to said mat fibers by electrostatic and/or Van der Waal forces.

6. A primary backing mat according to claim 1, wherein said thermoplastic polymer particles are anchored to said mat fibers by subjecting said mat to a temperature sufficient to make the thermoplastic polymer particles tacky.

7. A method for manufacturing a primary backing mat according to claim 1, wherein said coating is carried out by:
(a) charging said mat of woven or non-woven fibers with an electrostatic charge,
(b) charging said thermoplastic polymer particles with an electrostatic charge opposite to that of said fibers, and
(c) distributing said charged thermoplastic polymer particles in an air stream that passes adjacent said charged woven or non-woven mat fibers to deposit said charged thermoplastic particles over said mat of charged woven or non-woven fibers.

8. A method for manufacturing a carpet comprising:
(a) forming a primary backing mat comprised of mat fibers arranged so that the primary backing mat has a plurality of openings, said mat fibers having an exterior surface coated with thermoplastic polymer particles of a thermoplastic material having a melting temperature lower than that of said mat fibers;
(b) tufting carpet fiber yarn between said openings in said primary backing mat, thereby forming a tufted primary backing mat, and
(c) heating said tufted primary backing mat in a post tufting heat treatment process to melt said thermoplastic polymer particles thereby creating a bond between the tufted carpet yarn and said mat fibers.

9. A method for manufacturing a carpet according to claim 8, wherein said heating step is carried out at a temperature of approximately 115 to 120° C., and said thermoplastic polymer particles are composed of a low density weight polyethylene.

10. A method for manufacturing a carpet according to claim 8, wherein said heating step is carried out at a temperature of approximately 135 to 140° C. and said thermoplastic polymer particles are composed of a high density polyethylene.

11. A method for manufacturing a carpet according to claim 8, wherein said heating step is conducted at a temperature of approximately 160 to 175° C. and said thermoplastic polymer particles are composed of polypropylene.

12. A method for manufacturing a carpet according to claim 8, wherein said mat fibers comprise fibers selected from the group consisting of nylon 6, nylon 6,6, polyester, polypropylene, and mixtures of the foregoing.

13. A method for manufacturing a carpet according to claim 8, wherein said thermoplastic polymer particles are selected from the group consisting of polyethylene, polypropylene, and mixtures of the foregoing.

14. A method for manufacturing a carpet according to claim 8, wherein said tufted carpet yarn fibers are selected from the group consisting of nylon 6, nylon 6,6, wool, polyester, polypropylene fibers, and mixtures of the foregoing.

15. A method for manufacturing a carpet according to claim 8, wherein said mat fibers are comprised of nylon 6 fibers coated with polyethylene particles, and are tufted with nylon 6 carpet yarn fibers.
